(19) United States
(12) Patent Application Publication
(10) Pub. No.: US 2026/0160263 A1
(43) Pub. Date: Jun. 11, 2026

(54) STATOR FOR A FLUID MACHINE, FLUID MACHINE COMPRISING SUCH A STATOR, AND METHOD FOR MANUFACTURING SUCH A STATOR

(71) Applicant: L'Air Liquide, Societe Anonyme pour l'Etude et l’Exploitation des Procedes Georges Claude, Paris (FR)

(72) Inventor: Youssef ABDO, Paris (FR)

(21) Appl. No.: 19/407,478

(22) Filed: Dec. 3, 2025

(30) Foreign Application Priority Data
Dec. 6, 2024 (FR) FR2413559

(51) Int. Cl. F04D 29/42; B33Y 10/00; B33Y 80/00; F04D 1/02; F04D 17/10

(52) U.S. Cl. CPC F04D 29/42; F04D 1/02; F04D 17/10; B33Y 10/00; B33Y 80/00

(57) ABSTRACT

A stator for a fluid machine, comprising: a volute in the form of a channel defined about the stator and delimited by a side wall comprising a first end wall and a second end wall which define a maximum height of the volute, the side wall also comprising an internal perimeter and an external perimeter defining a maximum width of the volute, a pipe connected to the volute and, together with the volute, delimiting a circuit for the flow of a fluid between an inlet section and an outlet section, a set of one or more vanes arranged in the circuit for the flow of the fluid, the volute, the pipe and the set of one or more vanes are produced in a single piece by an additive manufacturing process.

### CROSS REFERENCE TO RELATED APPLICATIONS

This application claims the benefit of priority under 35 U.S.C. § 119(a) and (b) to French patent application No. FR2413559, filed Dec. 6, 2024, which is herein incorporated by reference in its entirety.

### FIELD OF THE INVENTION

The invention relates to a stator for a fluid machine and to a fluid machine comprising such a stator. The fluid machine may be a centripetal turbomachine or a centrifugal compressor. The invention also relates to a method for manufacturing such a stator by 3D printing. It can be in particular a selective laser manufacturing method.

### BACKGROUND OF THE INVENTION

A centripetal turbomachine or a centrifugal compressor comprises, in a known manner, a stator and a rotor configured to rotate in relation to the stator.

The stator comprises a volute and a pipe connected to the volute. The volute and the pipe delimit a circuit for the flow of a fluid between an inlet section and an outlet section. The flow circuit is provided with a set of one or more vanes.

In particular, the volute is in the form of a helical channel which is defined about a main axis of the stator and comprises a first end wall and a second end wall opposite the first end wall in a direction parallel to the main axis. The pipe extends along the main axis.

These various stator elements, i.e. the volute, the pipe and the set of one or more vanes, represent a significant proportion of the cost of manufacturing a radial turbomachine. This is because these stator elements, and in particular the volute, have a complex shape and require very high precision and very advanced techniques to manufacture.

For the most common turbocompressors, in particular those used in the automotive industry, the stator elements are produced by casting. Moulds are then needed to facilitate mass production and reduce costs. Furthermore, reworking by machining may be necessary, or even essential, depending on the casting technique used, and depending on the field of application of the fluid machine. Reworking by forging is conceivable in some cases.

These steps of preparing moulds, moulding and finish-grinding represent a significant cost that needs to be reduced.

For machines custom-made in small quantities, or for machines produced for prototyping, manufacturing by casting is not recommended, in particular when these machines are small in size (<10 kW). Instead of casting, machining is generally preferred.

Machining requires (multi-axial) numerically controlled precision machines or electrical discharge machining technologies. The use of these manufacturing technologies also involves a certain cost which needs to be reduced.

Irrespective of the method used (casting then reworking, precision machining) for the manufacture of the stator elements, a final step of assembling is necessary. Such assembling is generally complex, in particular because it must ensure a good leaktightness between the assembled elements. To this end, use is made of specific seals and assembly methods, resulting in an increase in the manufacturing cost.

In order to reduce this cost, the use of 3D printing seems to be a promising solution. However, in spite of the progress made in this field in recent years, there is still a certain number of limitations or challenges that must be overcome.

These limitations include primarily a low degree of precision on the parts obtained by 3D printing. Specifically, the closest tolerances on such parts are still often greater than approximately 0.1 mm.

Furthermore, 3D printing manufacturing methods do not always ensure a perfect concentricity and circular symmetry on cylindrical or conical surfaces. This is especially the case when the parts manufactured have a relatively large diameter (greater than 30 mm).

Similarly, 3D printing manufacturing methods, in particular laser fusion methods, have the drawback of not ensuring a uniform diffusion of heat in the volume of the component in the course of manufacture. A non-uniform diffusion leads to a lack of flatness of the parts, thus compromising the leaktightness of the systems in which these parts must be integrated.

Lastly, with 3D printing manufacturing methods it is often complicated to construct undercut surfaces, i.e. unsupported surfaces. One solution to this problem entails the use of supports distributed in the area of manufacture of the part. These supports are intended to support layers of material.

However, a component has been formed by 3D printing using supports, it can be difficult to remove these supports from the component obtained, in particular when these supports are positioned at the undercut areas of the part.

### SUMMARY OF THE INVENTION

One object of the invention is to at least partially overcome the drawbacks listed above.

To this end, according to a first aspect, the invention relates to a stator for a fluid machine, such as a centripetal turbomachine or a centrifugal compressor.

The stator comprises a volute and a pipe connected to the volute. The pipe and the volute delimit a circuit for the flow of a fluid between an inlet section and an outlet section. The stator also comprises a set of one or more vanes arranged in the circuit for the flow of the fluid.

In particular, the volute is in the form of a channel defined about a main axis of the stator and delimited by a side wall. The pipe extends along the main axis of the stator.

The side wall of the volute comprises a first end wall and a second end wall opposite the first end wall in a direction parallel to the main axis. The side wall of the volute also has an internal perimeter adjacent to the main axis and an external perimeter opposite the inner perimeter in a direction perpendicular to the main axis.

The first end wall and the second end wall define a maximum height of the volute. The internal perimeter and the external perimeter define a maximum width of the volute.

According to this first aspect of the invention, the volute, the pipe and the set of one or more vanes are produced in a single piece by an additive manufacturing process. Furthermore, the ratio of the maximum width to the maximum height of the side wall of the volute is less than or equal to 30%. Lastly, except for a portion of the second end wall and a portion of the first end wall each having a chord of length less than or equal to 70% of the maximum width, any plane tangent to the side wall of the volute forms an angle of less than 45° in absolute terms with the main axis of the stator.

The term “chord” means the distance between the ends of the first end wall (and respectively the second end wall). Furthermore, the “tangent plane” is understood as meaning a tangent plane defined in relation to an internal face of the side wall of the volute.

As a result, the invention according to this first aspect makes it possible to reduce the cost of manufacturing the stator by integrating the volute, the pipe and the set of one or more vanes in a single manufacturing process. The invention therefore makes it no longer necessary to assemble various stator elements that were obtained separately, as is the case in the prior art. In this way, the invention makes it possible to eliminate the risk of leaks inherent to a component obtained by assembling separate elements.

In addition, by establishing a certain maximum angle between any plane tangent to the side wall of the volute and the main axis of the stator, and by establishing for the first end wall and the second end wall a chord length less than or equal to a predetermined threshold value lower than the maximum width of the side wall of the volute, the invention eliminates the risk of any of these end walls sagging during the manufacture of the stator by 3D printing. Each of the end walls is thus self-supporting.

Moreover, embodiments of the invention according to this first aspect of the invention may comprise one or more of the following features:
the volute delimits a volume provided for the passage of the fluid and accommodating a set of one or more reinforcements extending between the first end wall and the second end wall,
the reinforcements are distributed angularly in the volute about the main axis,
the pipe has a first end connected to the side wall of the volute and a free second end forming the inlet section of the stator or the outlet section of the stator,
the first end of the pipe is connected to the internal perimeter of the volute,
the set of one or more vanes is located close to the first end of the pipe,
the set of one or more vanes extends about the main axis of the stator in a circle defined by the first end of the pipe,
the side wall of the volute comprises a first portion which forms a loop extending about the main axis, and a straight second portion tangent to the first portion,
the second portion forms the inlet section or the outlet section of the stator,
the side wall of the volute has a variable cross section along a directrix of the side wall of the volute,
the maximum height and/or the maximum width of the side wall of the volute are variable along the directrix,
the cross section of the side wall of the volute has an elliptical overall shape of major axis corresponding to the maximum height and of minor axis corresponding to the maximum width,
the volute is provided with a base extending from the first end wall in a direction parallel to the main axis and away from the pipe,
the base extends from the first portion of the side wall of the volute in a circle defined by the directrix,
the volute, the pipe and the set of one or more vanes form a first part of the stator,
the stator comprises a second part intended to cooperate with the first part to allow a rotor to be mounted in the stator,
the first part and the second part of the stator are produced separately,
the second part of the stator is configured to be received in an opening formed by the base,
the stator comprises a seal arranged between the first part and the second part,
the first part and the second part of the stator are produced in a single piece by the additive manufacturing process,
the cross section of the side wall of the volute has a variable characteristic dimension along the directrix,
the volute is provided with a base extending from the first end wall in a direction parallel to the main axis and away from the pipe,
the base extends from the first portion of the side wall of the volute in a circle defined by the directrix,
the volute, the pipe and the set of one or more vanes form a first part of the stator,
the stator comprises a second part intended to cooperate with the first part to allow a rotor to be mounted in the stator,
the first part and the second part of the stator are produced separately,
the second part of the stator is configured to be received in an opening formed by the base,
the stator comprises a seal arranged between the first part and the second part,
the first part and the second part are produced in a single piece by the additive manufacturing process.

According to a second aspect, the invention relates to a fluid machine comprising a stator according to any one of the embodiments of the first aspect described above. The machine also comprises a rotor arranged inside the stator.

According to a third aspect, the invention relates to a process for manufacturing, by 3D printing, a stator according to any one of the embodiments of the first aspect described above.

Furthermore, embodiments according to this third aspect of the invention may comprise one or more of the following features:
the process comprises a step of manufacturing, by 3D printing, a blank having a shape similar to that of the finished stator and an average thickness greater than that of the finished stator,
the process also comprises a step of finish-grinding the blank to a desired average thickness on the finished stator,
the blank comprises a preform of the volute, a preform of the pipe, and a preform of the set of one or more vanes,
the preform of the pipe is provided with an extension along the main axis, the extension being configured to make it easier to handle the blank during the finish-grinding step,
the step of manufacturing the blank comprises an operation of determining a chord of a first end wall and a chord of a second end wall of the preform of the volute as a function of an average thickness of a wall delimiting the preform of the volute,
the step of manufacturing the blank comprises an operation of determining a chord of a first end wall and a chord of a second end wall of the preform of the volute as a function of parameters of the additive manufacturing process, such as the orientation of a laser beam in relation to a powder bed, the melting temperature of the powder,
the step of manufacturing the blank comprises an operation of determining a minimum distance between two consecutive reinforcements as a function of an average thickness of a wall delimiting the preform of the volute,
the step of manufacturing the blank comprises an operation of determining a minimum distance between two consecutive reinforcements as a function of a diameter of the pipe,
the step of manufacturing the blank comprises an operation of determining a minimum distance between two consecutive reinforcements as a function of parameters of the additive manufacturing process, such as the orientation of a laser beam in relation to a powder bed, the melting temperature of the powder and the material used,
the step of manufacturing the blank by 3D printing comprises an operation of superimposing layers of powder, including a lower layer intended to form a free end of the preform of the pipe and an upper layer intended to form a first end wall of the preform of the volute,
the lower layer is formed before the upper layer so that, after the step of manufacturing the blank, the preform of the pipe faces downwards and the preform of the volute faces upwards.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further specific features and advantages will become apparent upon reading the description below, which is provided with reference to the following figures, in which:

FIG. 1 is an isometric sectional view illustrating an example of a fluid machine according to a first embodiment of the invention, the machine being illustrated in a front view and comprising a stator and a rotor.

FIG. 2 is an isometric sectional front view illustrating the stator of the machine shown in FIG. 1.

FIG. 3 is an isometric sectional view illustrating the stator of the machine shown in FIG. 1, the stator being illustrated in a bottom view.

FIG. 4 is an isometric top view illustrating a second embodiment of the fluid machine according to the invention.

FIG. 5 is an isometric sectional view illustrating the stator of the machine shown in FIG. 4, the stator being illustrated in a bottom view.

FIG. 6 is an isometric sectional view illustrating the stator of the machine shown in FIG. 4, the stator being illustrated in a front view.

FIG. 7 is an isometric front view illustrating a blank of the stator of the machine shown in FIG. 4, the blank being obtained by 3D printing.

FIG. 8 illustrates steps of a process for manufacturing the stator of the machine according to the invention.

### DETAILED DESCRIPTION OF THE INVENTION

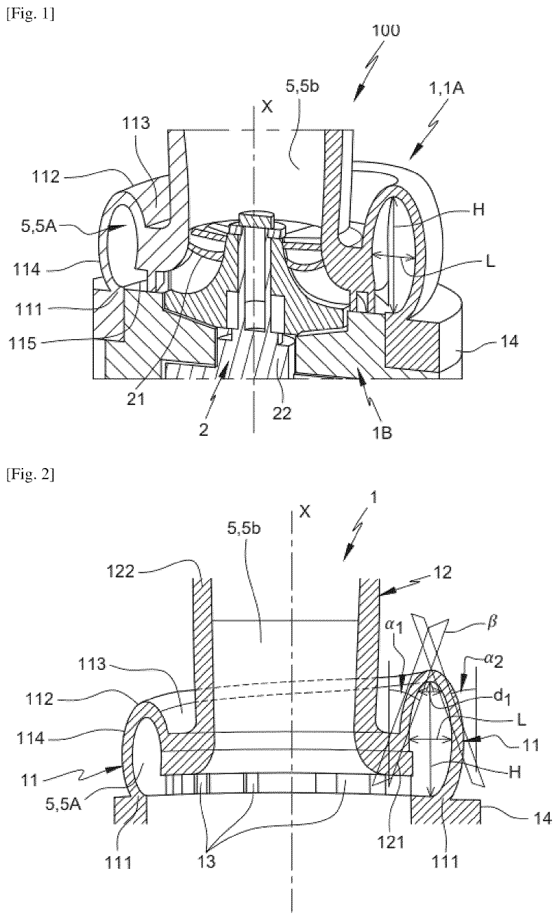

With reference to FIG. 1 and FIG. 4, the invention relates to a fluid machine 100 such as a centripetal turbomachine or a centrifugal compressor. The machine 100 comprises a stator 1 and a rotor 2 configured to rotate in relation to the stator 1. The rotor 2 can be seen in FIG. 1.

In particular, the rotor 2 comprises a set 21 of one or more blades arranged about an axis 22. The rotation of the set 21 of one or more blades makes it possible to accelerate the rate of flow of the fluid through the stator 1. It should be noted that the shaft 22 of the rotor 2 can be connected to an actuator controlled for example via an electronic control system.

The stator 1 comprises a first part 1A and a second part 1B which cooperate in order to hold the rotor 2 in position in the stator 1. The second part 1B has a relatively simple structure. It can be produced by any technique known to those skilled in the art. On the other hand, the first part 1A has a more complex structure. It is the subject of the present invention and the detailed description which follows.

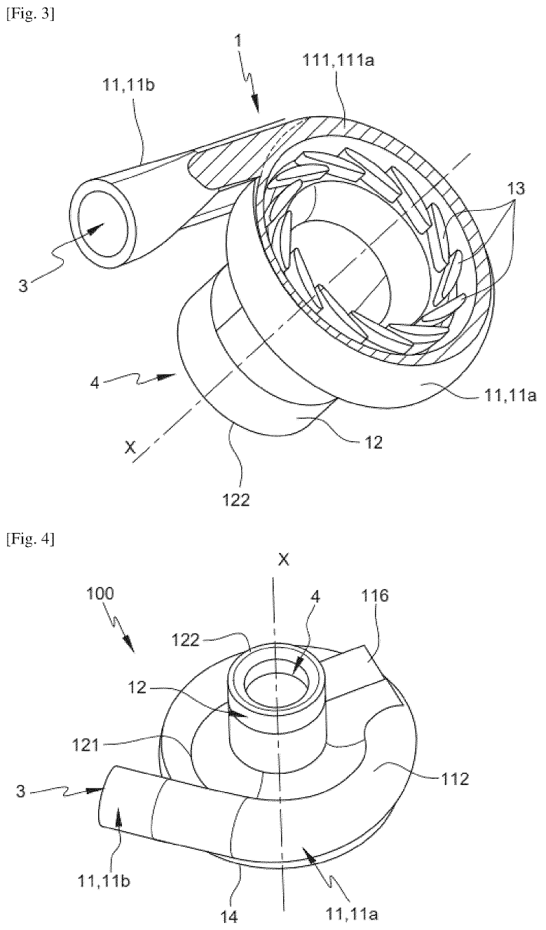

With reference to FIG. 3 and FIG. 4, the first part 1A of the stator 1 comprises a volute 11 and a pipe 12 connected to the volute 11. The volute 11 and the pipe 12 each define a fluid inlet section 3 or a fluid outlet section 4. In addition, the volute 11 and the pipe 12 together delimit a circuit 5 for the flow of the fluid in the stator 1. The circuit 5 for the flow can be seen in particular in FIG. 2.

The circuit 5 for the flow extends between the inlet section 3 and the outlet section 4. In addition, the circuit 5 for the flow is provided with a set 13 of one or more vanes which can be distributed angularly about the main axis X. The set 13 of one or more vanes can be seen in particular in FIG. 3.

In order to ensure the leaktightness of the stator 1, in particular between the first part 1A and the second part 1B, the stator 1 comprises a set 6 of one or more seals (illustrated in FIG. 1). In particular, a polymer first seal and a metal second seal can be provided. The material of the metal seal can be chosen depending on the application. It may be indium, which remains flexible to a certain degree at cryogenic temperatures.

Still with reference to FIG. 3 and FIG. 4, the volute 11 is in the form of a channel defined about a main axis X of the fluid machine 100. The channel is delimited by a side wall which defines a first volume 5a of the circuit 5 for the flow. In the example illustrated, the volute 11 extends helically about the main axis X.

In more detail, the side wall of the volute 11 comprises a first portion 11a which extends in a closed loop about the main axis X, and a straight second portion 11b tangential to the first portion 11a. The second portion 11b forms the inlet section 3 (in the case of a turbine) or the outlet section 4 (in the case of a compressor).

Furthermore, the side wall of the volute 11 has a first end wall 111 (referred to as the base) and a second end wall 112 opposite the first end wall 111 in a direction parallel to the main axis X. The first end wall 111 and the second end wall 112 define a maximum height H of the side wall of the volute 1. The second end wall 112 is convex. It is referred to as “supported” with respect to the first end wall 111.

“Supported” is understood as meaning the fact that the second end wall 112 is located at a certain distance from the first end wall 111, and the fact that its projection onto the latter is not reduced at any point. In other words, when it is virtually isolated from the rest of the side wall of the volute 1, the second end wall 112 is suspended in relation to the first end wall 111.

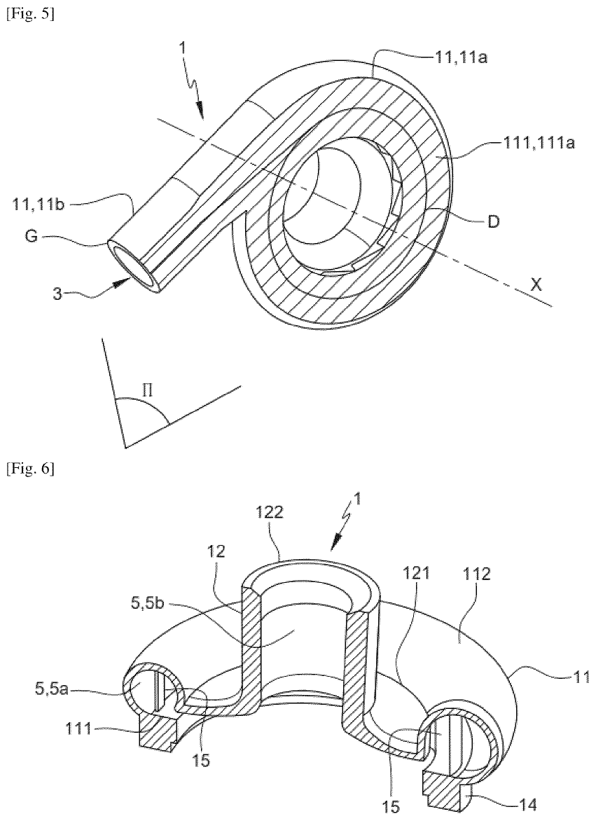

With reference to FIG. 5, the first end wall 111 is located in a main plane π of the stator 1. In addition, the first end wall 111 defines a ring 111a formed by the first portion 11a of the side wall of the volute 11.

It should be noted that the main plane π of the stator 1 is perpendicular to the main axis X. In addition, the main plane π of the stator 1 contains a helical directrix D.

Again with reference to FIG. 1 and FIG. 2, the side wall of the volute 11 has an internal perimeter 113 adjacent to the main axis X and an external perimeter 114 opposite the internal perimeter 113 in a direction perpendicular to the main axis X. The external perimeter 114 extends around the internal perimeter 113. The internal perimeter 113 and the external perimeter 114 define a maximum width L of the side wall of the volute 11.

In more detail, the internal perimeter 113 of the side wall of the volute 11 is formed by the first portion 11a. In addition, the internal perimeter 113 of the side wall of the volute 11 is in the form of a cylindrical band defined about the main axis X. Lastly, the internal perimeter 113 of the side wall of the volute 11 has an opening 115 intended to ensure fluidic communication between the volute 11 and the pipe 12. The opening 115 can be seen in FIG. 1.

In the example illustrated, the opening 115 extends over the entire length of the internal perimeter 113 of the side wall of the volute 11. In addition, the opening 115 is formed close to the first end wall 111.

The external perimeter 114 of the side wall of the volute 11 is in the form of a band which is folded back on itself to describe the shape of a “6”. A part of the external perimeter 114 of the side wall of the volute 11 is formed by the first portion 11a of the volute 11. Another part of the external perimeter 114 of the side wall of the volute 11 is formed by the second portion 11b of the side wall of the volute 11.

With reference to FIG. 4, the volute 11 may be provided with a block 116 intended to receive various sensors (for pressure, temperature, rotational speed) in the volume 5a delimited by the side wall of the volute 11. Advantageously, this block 116 is formed at the second end wall 112 of the side wall of the volute 11.

With reference to FIG. 5, the side wall of the volute 11 has a cross section G (also referred to as a generatrix) which can be closed or semi-closed. In other words, the side wall of the volute 11 is created by the travel of the generatrix G along the directrix D defined in the main plane π of the stator 1.

The generatrix G can have a variable characteristic dimension along the directrix D. The characteristic direction may be in this case the maximum height H of the side wall of the volute 11, or the maximum width L of the side wall of the volute 11.

With reference to FIG. 1 to FIG. 4 and FIG. 6, the pipe 12 extends along the main axis X of the stator 1. In addition, the pipe 12 delimits a second volume 5b of the circuit 5 for the flow. The second volume 5b communicates with the first volume 5a delimited by the side wall of the volute 11. Lastly, the pipe 12 has a first end 121 and a free second end 122.

In the example illustrated in particular in FIG. 2 and FIG. 6, the pipe 12 has a flared overall shape at the ends 121, 122. In particular, the first end 121 of the pipe 12 is connected to the internal perimeter 113 of the volute 11. In addition, the first end 121 forms a ring which extends parallel to the first end wall 111. This ring bears the set 13 of one or more vanes. Furthermore, the second end 122 forms the inlet section 3 or the outlet section 4 of the stator 1.

As illustrated in FIG. 1, FIG. 2 and FIG. 6, the side wall of the volute 11 is advantageously provided with a base 14.

In particular, the base 14 extends from the first end wall 111 in a direction parallel to the main axis X and away from the pipe 12. More specifically, the base 14 extends from the ring 111a defined by the first end wall 111. Furthermore, the base 14 has an outside diameter greater than the outside diameter of the first portion 11a of the volute 11. Lastly, the base 14 forms an opening for receiving the second part 1B of the stator 1.

According to a first embodiment of the invention, the volute 11, the pipe 12 and the set 13 of one or more vanes are produced in a single piece obtained by an additive manufacturing process 200.

As a result, the invention makes it possible to reduce the cost of manufacturing the stator 1 by integrating the volute 11, the pipe 12 and the set 13 of one or more vanes in a single manufacturing process. In addition, the invention means that it is no longer necessary to assemble various stator elements that were obtained separately, as is the case in the prior art. In this way, the invention makes it possible to eliminate the risk of leaks inherent to a component obtained by assembling separate elements.

According to a second embodiment in combination with the first embodiment described above, and as illustrated more clearly in FIG. 2, the ratio of the maximum width L to the maximum height H of the side wall of the volute 11 is less than or equal to 30%. In addition, except for a portion of the second end wall 112 and a portion of the first end wall 111 each having a chord d1 of length less than or equal to 70% of the maximum width L, any plane β tangent to the side wall of the volute 11 forms an angle α of less than 45° in absolute terms with the main axis X.

The term “chord” means the distance between the ends of the first end wall 111 (and respectively the second end wall 112). Furthermore, the “tangent plane” is understood as meaning a tangent plane defined in relation to an internal face of the side wall of the volute 11.

By establishing a certain maximum angle between any plane β tangent to the side wall of the volute 11 and the main axis X of the stator 1, and by establishing for the first end wall 111 and the second end wall 1122 a chord length d1 less than the maximum width L of the side wall of the volute 11, the invention eliminates the risk of any of these end walls 111, 112 sagging during the manufacture of the stator 1 by 3D printing. Each of the end walls 111, 112 is thus self-supporting.

It should be noted that, for this second embodiment of the invention, various profiles can be envisaged for the generatrix G of the side wall of the volute 11 provided that the angle α remains less in absolute terms than the predetermined maximum angle, and that the chord d1 of the first end wall and of the second end wall 112 remains less than or equal to the predetermined threshold value.

In the example illustrated in FIG. 2, the generatrix G has substantially the shape of a semi-open ellipse. This ellipse has a major axis which corresponds to the maximum height H, and a minor axis which corresponds to the maximum width L.

The major axis decreases along the directrix D from the second portion 11b of the volute 11 towards the first portion 11a of the volute 11. Owing to this variation in the major axis along the directrix D, the second end wall 112 of the volute 11 is inclined in relation to the main plane π of the stator 1.

According to a third embodiment of the invention in combination with the first embodiment, and as illustrated more clearly in FIG. 6, the volute 11 is provided with a set 15 of one or more reinforcements which extends between the first end wall 111 and the second end wall 112.

Thus, the set 15 of one or more reinforcements is configured to support the second end wall 112 or the first end wall 111, in particular while the stator 1 is being additively manufactured. In other words, the set 15 of one or more reinforcements prevents any sagging of the second end wall 112 or of the first end wall 111 during the additive manufacturing.

If there is a plurality of reinforcements 15, they are arranged angularly in the circuit 5 delimited by the volute 11 and the pipe 12. A predefined minimum angular distance can be provided between two consecutive reinforcements 15.

The generatrix G of the side wall of the volute 11 according to this third embodiment may have a circular shape, as illustrated in particular in FIG. 6, and not necessarily an elliptical shape as is the case in the second embodiment, illustrated in FIG. 2.

To manufacture the stator 1 according to any one of the embodiments described above, the invention introduces a new process 200 which is described below. It is a 3D printing manufacturing process.

The process 200 comprises a step S1 of manufacturing, by 3D printing, a blank 1-bis which has a shape similar to that of the finished stator 1 and an average thickness greater than that of the finished stator 1. The process 200 also comprises a step S3 of finish-grinding the blank 1-bis to a desired average thickness on the finished stator 1.

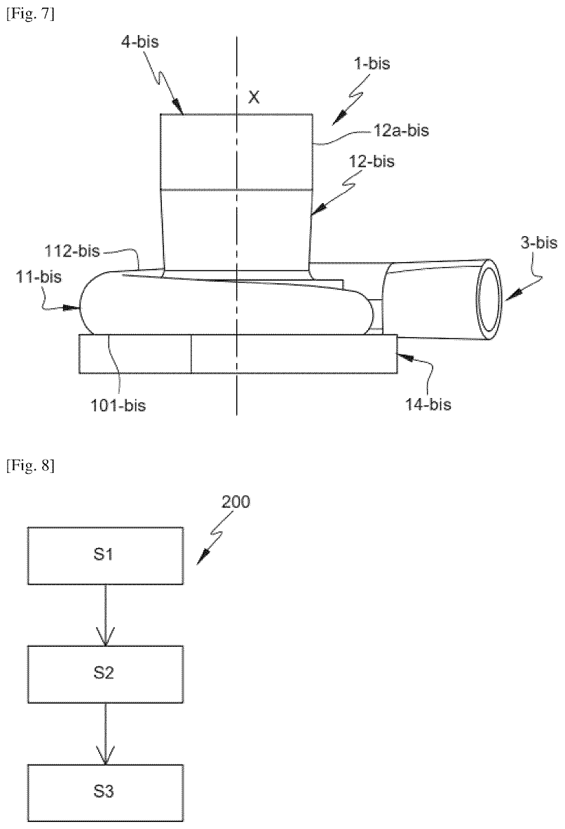

With reference to FIG. 7, the blank 1-bis comprises a preform 11-bis of the volute 11 and a preform 12-bis of the pipe 12. The preform 12-bis of the pipe 12 is connected to the preform 11-bis of the volute 11. The two preforms 11-bis, 12-bis delimit a preform (not illustrated) of the circuit 5 for the flow of the fluid, this circuit extending between a preform 3-bis of the inlet section 3 and a preform 4-bis of the outlet section 4.

The blank 1-bis also comprises a set (not illustrated) of preforms of the vanes 13. This set of preforms of the vanes 13 is arranged in the preform of the circuit 5.

In particular, the preform 11-bis of the volute 11 comprises all of the features of the volute 11 as were described above. The preform 11-bis of the volute 11 comprises in particular a preform 14-bis of the base 14. The preform 11-bis of the volute 11 may also comprise a set of preforms of reinforcements 15 (for the stator according to the third embodiment).

Advantageously, the preform 12-bis of the pipe 12 is provided with an extension 12a-bis which extends along a main axis identical to the main axis X of the finished stator 1. This extension 12a-bis is intended to make it easier to handle the blank 1-bis during step S3 of finish-grinding, for example by means of a mandrel of a machine tool.

Advantageously, the step of manufacturing the blank 1-bis may comprise an operation of determining a chord of a first end wall 111-bis and a chord of a second end wall 112-bis of the preform 11-bis of the volute 11 as a function of an average thickness of a wall delimiting the preform 11-bis of the volute 11, or as a function of the parameters of the additive manufacturing process 200.

Advantageously, the step of manufacturing the blank 1-bis may comprise an operation of determining the minimum angular distance between two consecutive preforms of the set of preforms of reinforcements 15. This minimum angular distance is determined as a function of an average thickness of a wall delimiting the preform 11-bis of the volute 11, or as a function of a diameter of the preform 12-bis of the pipe 12, or as a function of the parameters of the additive manufacturing process 200.

Among the process parameters taken into account to determine the chord of the first end wall 111-bis or of the second end wall 112-bis of the preform 11-bis of the volute 11, or the minimum angular distance between two consecutive preforms of the set of preforms of reinforcements 15, mention can be made of the orientation of a laser beam in relation to a powder bed, the melting temperature of the powder, the material of the powder, etc.

The diameter of the preform 12-bis of the pipe 12 is understood as meaning the hydraulic diameter given by Dh=4A/P, where A is the flow area of the preform 12-bis of the pipe 12 and P is the wetted perimeter of this section.

Advantageously, the step S1 of manufacturing the blank 1-bis by 3D printing comprises successive operations of depositing layers of powder one on top of another. Of these layers, a lower layer is intended to form a free end of the preform 12-bis of the pipe 12. An upper layer is intended to form a first end wall of the preform 11-bis of the volute 11.

The lower layer is deposited before the upper layer so that, after the step S1 of manufacturing the blank 1-bis, the preform 12-bis of the pipe 12 faces downwards whereas the preform 11-bis of the volute 11 faces upwards. This upside-down manufacture means that the set of preforms of the vanes 13 is not in the form of an undercut.

Between the step S1 of manufacturing the blank 1-bis by 3D printing and the step S3 of finish-grinding the blank 1-bis, a step S2 of depowdering the blank 1-bis may be provided. This involves removing excess, unmelted powder at the end of the 3D manufacturing step S1.

In order to make this depowdering easier, the blank 1-bis of the stator 1 can be manufactured in two separate parts: a first part forming a preform of the first part 1A of the stator 1, and a second part forming a preform of the second part 1B of the stator 1.

If the depowdering does not pose any difficulties, the blank 1-bis of the stator 1 can be manufactured in a single piece. To this end, the geometry and/or the number of preforms of the vanes 13 can be modified accordingly to give these preforms of the vanes 13 a function of supporting the “supported” portions.

The powder may be made of aluminium, stainless steel, Inconel (registered trademark) or titanium. The choice of material depends on the nature of the application and the physical operating conditions (thermodynamic, thermal, mechanical and of vibration) of the fluid machine 100.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A stator configured for a fluid machine selected from the group consisting of a centripetal turbomachine and a centrifugal compressor, the stator comprising:
a volute in the form of a channel defined about a main axis of the stator and delimited by a side wall comprising a first end wall and a second end wall opposite the first end wall in a direction parallel to the main axis, the side wall also comprising an internal perimeter adjacent the main axis and an external perimeter opposite the internal perimeter in a direction perpendicular to the main axis, the first end wall and the second end wall defining a maximum height of the volute, the internal perimeter and the external perimeter defining a maximum width of the volute;
a pipe connected to the volute and extending along the main axis, the pipe and the volute delimiting a circuit for the flow of a fluid between an inlet section and an outlet section; and
a set of one or more vanes arranged in the circuit for the flow of the fluid,
wherein the volute, the pipe and the set of one or more vanes are produced in a single piece by an additive manufacturing process, in that the ratio of the maximum width to the maximum height of the volute is less than or equal to 30%, and in that, except for a portion of the second end wall and a portion of the first end wall each having a chord of length less than or equal to 70% of the maximum width, any plane tangent to the side wall of the volute forms an angle of less than 45° in absolute terms with the main axis.

2. The stator as claimed in claim 1, wherein the pipe has a first end connected to the side wall of the volute and a free second end forming the inlet section of the stator or the outlet section of the stator.

3. The stator as claimed in claim 1, wherein the side wall of the volute comprises a first portion, which forms a loop extending about the main axis, and a straight second portion tangential to the first portion, the second portion forming the inlet section or the outlet section of the stator.

4. The stator as claimed in claim 1, wherein the side wall of the volute has a variable cross section along a directrix of the side wall of the volute.

5. The stator as claimed in claim 1,wherein the volute is provided with a base extending from the first end wall in a direction parallel to the main axis and away from the pipe.

6. The stator as claimed in claim 1, wherein the volute, the pipe and the set of one or more vanes form a first part of the stator, the stator comprising a second part intended to cooperate with the first part to allow a rotor to be mounted in the stator.

7. The stator as claimed in claim 6, wherein the first part and the second part of the stator are produced separately.

8. The stator as claimed in claim 6, comprising a seal arranged between the first part and the second part.

9. The stator as claimed in claim 6, wherein the first part and the second part are produced in a single piece by the additive manufacturing process.

10. A fluid machine selected from the group consisting of a centripetal turbomachine and a centrifugal compressor, the fluid machine comprising the stator as claimed in claim 1 and a rotor arranged inside the stator.

11. The process for manufacturing the stator as claimed in claim 1 by additive manufacturing.

12. The process as claimed in claim 11, further comprising manufacturing, by 3D printing, a blank having a shape similar to that of the finished stator and an average thickness greater than that of the finished stator; and finish-grinding the blank to a desired average thickness on the finished stator.

13. The process as claimed in claim 11, wherein the blank comprises a preform of the volute, a preform of the pipe, and a preform of the set of one or more vanes.

14. The process as claimed in claim 13, wherein the preform of the pipe is provided with an extension along the main axis, the extension being configured to make it easier to handle the blank during the step of finish-grinding.

15. The process as claimed in claim 13, wherein the step of manufacturing the blank by 3D printing comprises an operation of superimposing layers of powder, including a lower layer intended to form a free end of the preform of the pipe and an upper layer intended to form a first end wall of the preform of the volute, the lower layer being formed before the upper layer so that, after the step of manufacturing the blank, the preform of the pipe faces downwards and the preform of the volute faces upwards.
